(19) United States
(12) Patent Application Publication
(10) Pub. No.: US 2021/0243125 A1
(43) Pub. Date: Aug. 5, 2021

(54) SYSTEM AND METHOD FOR AVOIDING CONGESTION IN A COMPUTER NETWORK

(71) Applicant: Hewlett Packard Enterprise Development LP, Houston, TX (US)

(72) Inventors: Anil RAJ, Bangalore Karnataka (IN); Celestian Kaniampady SEBASTIAN, Bangalore Karnataka (IN); Jeswin AUGUSTINE, Bangalore Karnataka (IN)

(21) Appl. No.: 17/122,539

(22) Filed: Dec. 15, 2020

(30) Foreign Application Priority Data
Jan. 31, 2020 (IN) 202041004487

(51) Int. Cl. H04L 12/801; H04L 12/841; G06N 20/00; G06N 5/04

(52) U.S. Cl. CPC H04L 47/127; G06N 5/04; G06N 20/00; H04L 47/28

(57) ABSTRACT

The present invention relates a system and a method for avoiding congestion in a computer network. Information related to a flow of query data packets in the computer network and a capacity of the computer network is collected for processing. A pattern in the flow of query data packets is determined based on the collected information and a trained data model. The trained data model is used to determine occurrence of an impending connection data burst, in the computer network, which is capable of causing congestion in the computer network. The connection data burst comprises information related to links within routing devices present in the computer network. Upon determining occurrence of the impending connection data burst, parameters configured in the routing devices are modified to avoid the congestion of the computer network by the impending connection data burst.

### BACKGROUND

A computer network is generally utilized for sharing resources and data. Typically, number of network devices within a network define the type of computer network. Switches and routers are the essential network devices used in implementing a computer network. Switch is a network device used for connecting several other network devices/nodes present in a computer network. Data is communicated between such network devices nodes in form of data packets. A router performs the function of delivering such data packets through one or more network paths, based on a routing technique implemented on the router.

Therefore, all the network devices present in a computer network communicate with each other in a predefined manner, using a predefined set of instructions called communication protocols. Specifically, several communication protocols exist and are utilized for establishing communication between the network devices for different purposes. Determining and exchanging routing information is one such purpose that is accomplished using specialized protocols.

### BRIEF DESCRIPTION OF THE DRAWINGS

The accompanying drawings constitute a part of the description and are used to provide further understanding of the present invention. Such accompanying drawings illustrate the embodiments of the present invention which are used to describe the principles of the present invention together with the description. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates a network connection diagram of a system for avoiding congestion in a computer network, in accordance with an embodiment of the present invention.

FIG. 2 illustrates a block diagram showing different components of the system for avoiding congestion in a computer network, in accordance with an embodiment of the present invention.

FIG. 3 illustrates a data flow diagram, in accordance with an embodiment of the present invention.

FIG. 4 illustrates a flowchart showing a method for avoiding congestion in a computer network, in accordance with an embodiment of the present invention.

FIGS. 5a and 5b illustrate sample plots of data packets communicated over a computer network utilizing OSPF protocol.

### DETAILED DESCRIPTION OF THE INVENTION

Open Shortest Path First (OSPF) is a link-state routing protocol used in computer networks for providing robust and efficient routing support. Within a computer network, routers utilizing the OSPF protocol, mainly communicate with each other using Hello data packets and Link State Advertisement (LSA) data packets. Each router transmits the Hello packets to all of its neighbouring routers, to indicate its presence in the computer network. Within a computer network, LSAs are communicated by a router to other routers for informing the other routers about the list of routers connected with the router and distances between the router and connected routers.

For a large scale computer network utilizing several routers, there are instances where the amount of Link State Advertisement (LSA) information communicated between routers become enormous. Such vast amount of LSA information exchanged over a computer network is referred to as LSA storms. To process the information present in such LSA storms, Central Processing Unit (CPU) and memory utilization by each router increases tremendously. Most of the times, the LSA storms cause congestion in computer networks.

During such instances, while a computer network becomes congested upon arrival of an LSA storm, incoming packets such as Hello packets get delayed or dropped. Sometimes, the Hello packets get delayed beyond a router dead interval i.e. a time after which a network element is considered to be inactive in a computer network. Therefore, occurrence of delays in receipt of the Hello packets result in false understanding about a network element being inactive. Later, when Hello packets are received from such network elements falsely understood as being inactive, LSA retransmission occurs. For processing such additional LSAs, more CPU and memory space gets utilized, making the computer network unstable.

In order to overcome such existing problem, current disclosure provides a method adapted to modify parameters configured in routing devices of a computer network, to avoid congestion. Usage of Machine Learning (ML) techniques to analyse data flow in a computer network and avoiding occurrence of congestion in the computer network based on the analysis is described by current disclosure. Specifically, a data model is trained to understand a pattern of flow of data in a computer network, and occurrence of congestion in the computer network is predicted by the data model.

Upon making such prediction, parameters configured in routing devices present in the computer network are modified to avoid successive occurrence of congestion. For example, parameters modified in the routing devices include waiting time of query data packets i.e. Hello packets. By modifying waiting time of the query data packets, LSA storms could be processed by the routing devices, at first, and then the receipt of the Hello packets could be acknowledged, thereby maintaining stability of the computer network.

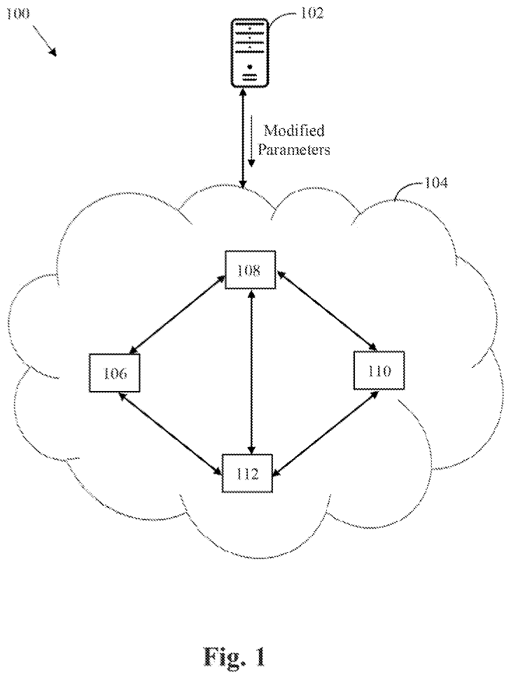

FIG. 1 illustrates a network connection diagram 100 of a system 102 for avoiding congestion in a computer network 104, in accordance with an embodiment of the present invention. The system 102 is connected to the computer network 104 comprising a group of routing devices and other networking devices. For the ease of illustration, the computer network 104 is shown to include a limited number of routing devices only. The routing devices include a first router 106, a second router 108, a third router 110, and a fourth router 112. However, numerous routing devices would generally be present in a typical computer network.

Further, the system 102 being connected to a computer network 104 would mean that the system 102 has a connection with one or many routing devices and/or other networking devices, to receive data being communicated within the computer network 104. Although the system 102 is illustrated to be present outside the computer network 104, it must be understood that the system 102 may be present within the computer network 104. Further, apart from being a separate device or group of devices, the system 102 may be implemented over any of the routing devices or the other networking devices present in the computer network 104. Amongst the routing devices, a specific router such as a Designated Router (DR) or a Backup Designated Router (BDR) may be programmed to provide the functionality of the system 102. Further, the other networking devices capable of hosting such service may include network switches. The system 102 may be configured to receive query data packets i.e. LSA data packets and Hello data packets exchanged between the routers 106 through 112, analyse a pattern of flow of the query data packets, and share modified parameters to the routers 106 through 112, for avoiding congestion of the computer network 104 by a connection data burst.

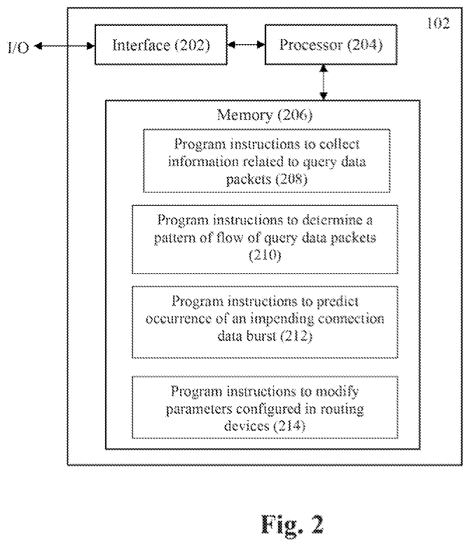

FIG. 2 illustrates a block diagram showing different components of the system 202 for avoiding congestion in the computer network 104, in accordance with an embodiment of the present invention. The system 202 may comprise an interface 202, a processor 204, and a memory 206. The memory 206 may store program instructions for performing several functions for avoiding congestion in the computer network 204. A few such program instructions stored in the memory 206 includes program instruction to collect information related to query data packets 208, program instructions to determine a pattern of flow of query data packets 210, program instructions to predict occurrence of an impending connection data burst 212, and program instructions to modify parameters configured in routing devices 214.

The program instructions to collect information related to query data packets 208 may cause the processor 204 to collect information related to a flow of the query data packets in the computer network 104 and a capacity of the computer network 104. The query data packets may include Link State Advertisement (LSA) data packets and Hello data packets. The program instructions to determine a pattern of flow of query data packets 210 may cause the processor 204 to determine the pattern of flow of query data packets by training a data model using a Machine Learning (ML) technique. The data model may analyse a pattern in the flow of query data packets and changes in the pattern, over a period of time, in order to obtain a trained data model.

The program instructions to predict occurrence of an impending connection data burst 212 may cause the processor 204 to predict occurrence of an impending connection data burst in the computer network 104, using the trained data model. The impending connection data burst may be an LSA storm. The program instructions to modify parameters configured in routing devices 214 may cause the processor 204 to modify parameters configured in routing devices 214 to avoid congestion of the computer network 104. The parameters may comprise a waiting time for receiving the query data packets i.e. the dead interval of the Hello packets. Detailed functioning of the program instructions 208 through 214 will become evident upon reading the details provided successively.

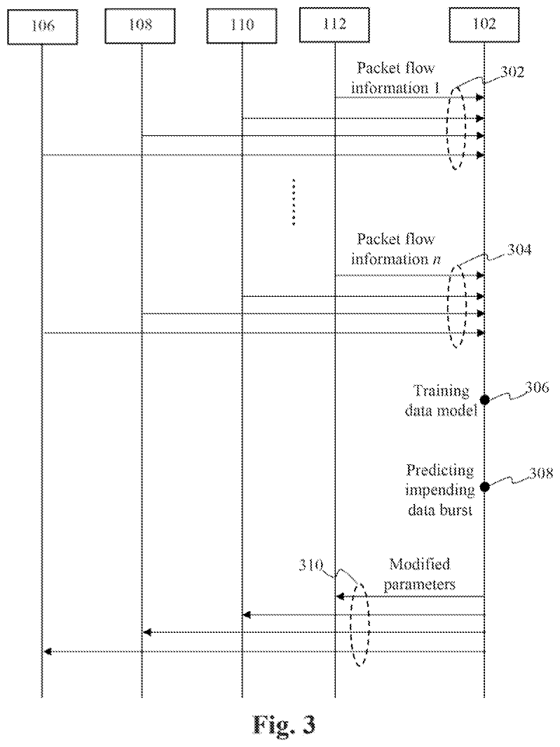

Referring to FIG. 3 illustrating a data flow diagram, functioning of the system 102 configured to modify parameters configured in routing devices is now disclosed. In one embodiment, query data packets may be exchanged between the routers 106, 108, 210, and 212 present in the computer network 104. The query data packets may include Hello data packets when Open Shortest Path (OSPF) routing protocol runs on the routers 106, 108, 110, and 112. Generally, the Hello data packets are exchanged between routing devices after every 10 seconds. Within a critical network, the Hello data packets may be exchanged after every 5 seconds. Receipt of the Hello data packets is also required to be acknowledged within a predefined time period known as dead interval. A routing device may be recognized to be inactive while an acknowledgement is not received, within the dead interval, in response to a Hello packet shared with the routing device. Typically, the dead interval is set as 15 seconds.

The query data packets may also comprise Link State Advertisement (LSA) data packets while OSPF routing protocol runs on the routers 106, 108, 110, and 112. A large number of LSA data packets flooded over the computer network 104 are called an LSA storm. It is required that the Hello data packet are received as well as receipt of the Hello data packets is acknowledged while the LSA storm arrives. A system described henceforth with reference to instances 302 through 306 describes an approach for addressing the Hello data packets while the LSA storm also arrives in the computer network 104.

At instance 302, the system 102 may collect information related to a flow of the query data packets in the computer network 104 and a capacity of the computer network 104. The packet flow information may be collected by the system 102 for a predefined number of times, i.e. ‘n’ times, as illustrated at instance 304. As already mentioned, the query data packets may include the LSA data packets and the Hello data packets. The LSA data packets and the Hello data packets may be collected by the system 102 as soon as they are transmitted over the computer network 104. In one case, each router may be programmed to share a copy of the query data packets to the system 102 while the query data packets are transferred to other routers.

Based on the flow of query data packets and the changes in the pattern analysed during ‘n’ instances, a data model may be trained, at instance 306. The trained data model may determine a pattern in the flow of query data packets using Machine Learning (ML) technique. The ML technique may utilize linear regression, Naïve Bayes, and Principal Component Analysis (PCA). In complex scenarios, the ML technique could also utilize Decision Tree, Random Forest, and Gradient Boosting-Random Forest methods. Over a period of time, the data model may analyse a pattern in the flow of query data packets and changes in the pattern, and thus a trained data model may be obtained. Such pattern in the flow of query data packets and changes in the pattern may be collected as data entries. In one implementation, such data entries may be collected by a dedicated network management component of a network switch present in the computer network 204. The network management component may be responsible for monitoring network events occurring in the computer network 104.

The trained data model may predict occurrence of an impending connection data burst in the computer network 104, at instance 308. The impending connection data burst may be an LSA storm. In an aspect, the impending connection data burst may be capable of causing congestion in the computer network 104. The impending connection data burst may comprise information related to links within the routing devices i.e. the routers 106, 108, 110, and 112 present in the computer network 104. Such information related to the links within the routing devices may include a type of link, a cost of the link, and adjacencies with neighbouring routing devices. The information related to the links within the routing devices may also include an identity of a neighbouring router, such as an Internet Protocol (IP) address and a subnet mask.

When the trained data model determines occurrence of the impending connection data burst capable of causing congestion in the computer network 104, parameters configured in the routers 106, 108, 110, and 112 may be modified, to avoid congestion of the computer network 104. Modified parameters may be communicated by the system 102 to the routers 106, 108, 110, and 112, at instance 310. The modified parameters may comprise a waiting time for receiving the query data packets i.e. the dead interval of the Hello packets. The dead interval may be extended based on severity of the impending connection data burst. After the impending connection data burst is processed, the waiting time for receiving the query data packets i.e. the dead interval may be reset to an original value, for example 10 seconds.

In alternate embodiments, the parameters to be modified may include a time for exchanging the LSA data packets between the routers 106, 108, 110, and 112, to avoid adjacency overlap. Further, the parameters to be modified may include a timing of transmission of the Hello data packets. In this manner, by extending timing of any of transmission of the Hello data packets, the dead interval related to the Hello data packets, and the LSA data packets, congestion could be avoided in the computer network 104.

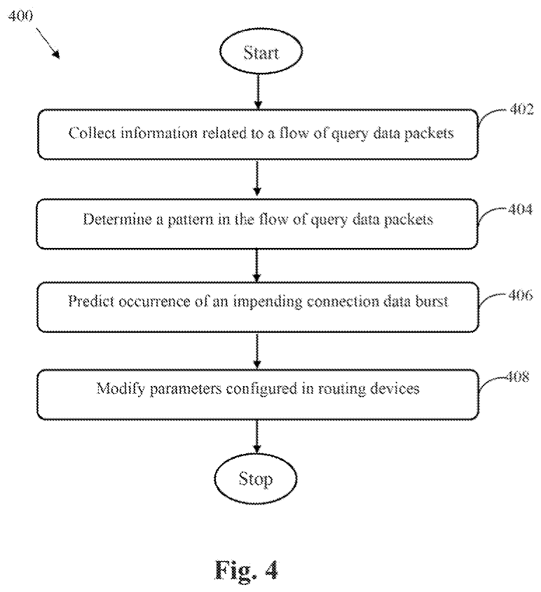

Referring now to FIG. 4, a method for modifying parameters configured in the routing devices is described with reference to the flowchart 400. In this regard, each block may represent a module, segment, or portion of code which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

At block 402, a system may collect information related to a flow of the query data packets in a computer network and a capacity of the computer network. The query data packets may include Link State Advertisement (LSA) data packets and Hello data packets. The LSA data packets and the Hello data packets may be collected by the system as soon as they are transmitted over the computer network.

At block 404, a data model may be trained by a Machine Learning (ML) technique, over the system. Over a period of time, the data model may analyse a pattern in the flow of query data packets and changes in the pattern, and thus a trained data model may be obtained upon such learning.

At block 406, occurrence of an impending connection data burst in the computer network may be predicted, using the trained data model. The impending connection data burst may be an LSA storm. The trained data model may predict occurrence of the impending connection data burst based on the flow of query data packets and the changes in the pattern analysed previously, over the computer network. The impending connection data burst may be capable of causing congestion in the computer network. The impending connection data burst may comprise information related to links between routing devices present in the computer network.

At block 408, parameters configured in the routing devices may be modified, to avoid congestion of the computer network, when the trained data model determines occurrence of the impending connection data burst capable of causing congestion in the computer network. The parameters may comprise a waiting time for receiving the query data packets i.e. the dead interval of the Hello packets. The dead interval may be extended based on severity of the impending connection data burst. After the impending connection data burst is processed, the waiting time for receiving the query data packets i.e. the dead interval may be reset to an original value.

Further, the parameters to be modified may include a time for exchanging the LSA data packets between the routing devices, to avoid adjacency overlap. Further, the parameters to be modified may include a timing of transmission of the Hello data packets. In this manner, by extending timing of any of transmission of the Hello data packets, the dead interval related to the Hello data packets, and the LSA data packets, congestion could be avoided in the computer network.

Apart from avoiding congestion of a computer network, current invention provides prevention of adjacency overlap, and significantly reduces the processing power that is generally utilized in retransmission of Hello data packets and LSA data packets while they get missed.

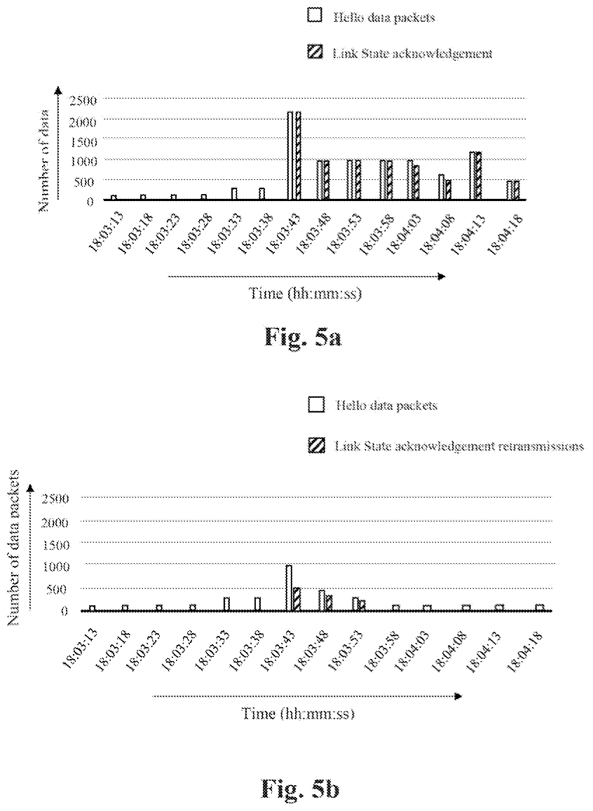

Referring to FIG. 5a illustrating a sample plot of data packets communicated over a computer network utilizing OSPF protocol, occurrence of LSA storms and their impact on a computer network is explained. Specifically, the data packets whose analysis is illustrated in the sample plot includes Hello data packets and Link State acknowledge retransmissions. The sample plot is prepared for a number of data packets (illustrated on y-axis) shown against time (illustrated on x-axis).

At time 18:03:43, an LSA storm arrives and causes Hello data packets to be missed for a first time. Successively, at time 18:03:48, Hello data packets are missed for a second time. Thereafter, at time 18:03:53, Hello data packets are missed for a third time. Later, at time 18:03:58, Hello data packets are missed for a fourth time. Once the Hello data packets are missed for the fourth time, adjacency may be declared as down i.e. the routers from which Hello data packets are missed for the fourth time, may be declared inactive. Then, at time 18:04:08, missed Hello data packets are processed successfully and adjacency is restored i.e. the routers from which the Hello data packets are received, may be declared active. Thereupon, at time 18:04:13, other LSA storm arrives that causes the Hello data packets to get missed.

FIG. 5b illustrates a sample plot of data packets communicated over a computer network utilizing OSPF protocol, in accordance with an embodiment of the present invention. Specifically, the data packets whose analysis is illustrated in the sample plot includes Hello data packets and Link State acknowledge retransmissions. The sample plot is prepared for a number of data packets (illustrated on y-axis) shown against time (illustrated on x-axis).

At time 18:03:43, an LSA storm arrives into the computer network and results into congestion of the computer network. Upon congestion, Hello data packets are missed for a first time by routing devices present in the computer network. This results in a significant rise in retransmission of the Hello data packets, as evident from a peak of Hello data packets illustrated at time 18:03:43. When the LSA storm arrives for the first time, the pattern related to the LSA storm, such as number of Link State acknowledge retransmissions and number of the Hello packets retransmitted or missed, during the LSA storm, are learned.

Based on such learning, arrival of an impending LSA storm in the computer network is predicted and parameters configured in the routing devices are modified to avoid congestion of the computer network by the impending LSA storm. Specifically, waiting time of query data packets i.e. Hello packets, set in the routing devices, is extended. Upon making such modification, count of the Hello data packets and the Link State acknowledgement transmissions reduces significantly, as illustrated in FIG. 5b, at time 18:03:48 and 18:03:53. Later, at time 18:03:58, retransmission of the Link State acknowledgement ceases and the computer network becomes completely stable. Once the impending LSA storm is processed and the computer network becomes stable, the waiting time modified in the routing devices, for receiving the query data packets, is reset to an original value. Thus, a drop in Hello packets and LSA retransmissions could be observed upon implementation of the invention described above, using several embodiments.

A computer network may be implemented using wired and/or wireless communication technologies. The computer network may comprise various network components such as switches, Provide Edge (PE) routers, Customer Edge (CE) routers, intermediate routers, bridges, computers, servers, and the like. Routing devices present in the computer network may implement an Interior Gateway Protocol (IGP) including, but not limited to, Open Shortest Path First (OSPF), Routing Information Protocol (RIP), Intermediate System to Intermediate System (IS-IS), and Enhanced Interior Gateway Routing Protocol (EIGRP).

An interface may be used to provide input or fetch output from the system. The interface may be implemented as a Command Line Interface (CLI) Graphical User Interface (GUI). Further, Application Programming Interfaces (APIs) may also be used for remotely interacting with the system.

A processor may include one or more general purpose processors (e.g., INTEL® or Advanced Micro Devices®, (AMD) microprocessors) and/or one or more special purpose processors (e.g., digital signal processors or Xilinx® System On Chip (SOC) Field Programmable Gate Array (FPGA) processor), MPS/ARM-class processor, a microprocessor, a digital signal processor, an application specific integrated circuit, a microcontroller, a state machine, or any type of programmable logic array.

A memory may include, but is not limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The detailed description provided above in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments.

The terms “or” and “and/or” as used above are to be interpreted as inclusive or meaning any one or any combination. Therefore, “A. B or C” or “A, B and/or C” mean “any of the following: A; B; C; A and B: A and C: B and C; A, B and C.” An exception to this definition will occur only when a combination of elements, functions, steps or acts are in some way inherently mutually exclusive.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components. Also, although the discussion focuses on uplink medium control with respect to frame aggregation, it is contemplated that control of other types of messages are applicable.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method comprising:
collecting information related to a flow of query data packets in a computer network and a capacity of the computer network;
determining a pattern in the flow of query data packets based on the collected information and a trained data model;
predicting occurrence of an impending connection data burst in the computer network using the trained data model, wherein the impending connection data burst is capable of causing congestion in the computer network, and wherein the impending connection data burst comprises information related to links within routing devices present in the computer network; and
modifying parameters configured in the routing devices to avoid the congestion of the computer network by the impending connection data burst, wherein the parameters comprise a waiting time for receiving the query data packets.

2. The method as claimed in claim 1, wherein the trained data model is developed using a Machine Learning (ML) technique for processing the information related to the computer network.

3. The method as claimed in claim 2, wherein the ML technique utilizes at least one of linear regression, Naïve Bayes, Principal Component Analysis (PCA), Decision Tree, Random Forest, and Gradient Boosting-Random Forest methods.

4. The method as claimed in claim 1, wherein the query data packets are at least one of a Link State Advertisement (LSA) data packets and Hello data packets.

5. The method as claimed in claim 1, wherein the information related to the links within the routing devices comprise a type of link, a cost of the link, and adjacencies with neighbouring routing devices.

6. The method as claimed in claim 1, further comprising resetting the waiting time for receiving the query data packets to an original value ater the impending connection data burst is processed.

7. A system comprising:
a processor; and
a memory connected to the processor, wherein the memory comprises programmed instructions which when executed by the processor, causes the processor to:
collect information related to a flow of query data packets in a computer network and a capacity of the computer network;
determine a pattern in the flow of query data packets based on the collected information and a trained data model;
predict occurrence of an impending connection data burst in the computer network using the trained data model, wherein the impending connection data burst is capable of causing congestion in the computer network, and wherein the impending connection data burst comprises information related to links within routing devices present in the computer network; and
modify parameters configured in the routing devices to avoid the congestion of the computer network by the impending connection data burst, wherein the parameters comprise a waiting time for receiving the query data packets.

8. The system as claimed in claim 7, wherein the trained data model is developed using a Machine Learning (ML) technique for processing the information related to the computer network.

9. The system as claimed in claim 8, wherein the ML technique utilizes at least one of linear regression, Nave Bayes, Principal Component Analysis (PCA), Decision Tree, Random Forest, and Gradient Boosting-Random Forest methods.

10. The system as claimed in claim 7, wherein the query data packets are at least one of a Link State Advertisement (LSA) data packets and Hello data packets.

11. The system as claimed in claim 7, wherein the information related to the links within the routing devices comprise a type of link, a cost of the link, and adjacencies with neighbouring routing devices.

12. The system as claimed in claim 7, further comprising resetting the waiting time for receiving the query data packets to an original value after the impending connection data burst is processed.

13. A non-transitory machine readable storage medium having stored thereon machine readable instructions to cause a computer processor to:
collect information related to a flow of query data packets in a computer network and a capacity of the computer network;
determine a pattern in the flow of query data packets based on the collected information and a trained data model;
predict occurrence of an impending connection data burst in the computer network using the trained data model, wherein the impending connection data burst is capable of causing congestion in the computer network, and wherein the impending connection data burst comprises information related to links within routing devices present in the computer network; and
modify parameters configured in the routing devices to avoid the congestion of the computer network by the impending connection data burst, wherein the parameters comprise a waiting time for receiving the query data packets.
